(19) United States
(12) Patent Application Publication
(10) Pub. No.: US 2026/0134412 A1
(43) Pub. Date: May 14, 2026

(54) BIOMETRIC RETROFIT DEVICE AND UNIVERSAL MOUNTING ASSEMBLY FOR POINT-OF-SALE, KIOSK, HANDHELD, DRIVE-THRU, AND ROBOTIC SYSTEMS

(71) Applicant: PopID, Inc., Diamond Bar, CA (US)

(72) Inventors: John Miller, Diamond Bar, CA (US); Sean Olson, Diamond Bar, CA (US); Anthony Lomelino, Diamond Bar, CA (US); Evan Grant, Diamond Bar, CA (US); Thomas Costello, Diamond Bar, CA (US); Ashish Gupta, Diamond Bar, CA (US); Andrew Ismailyan, Diamond Bar, CA (US); Quan Lim, Diamond Bar, CA (US); Emily Wang, Diamond Bar, CA (US); Jared Levine, Diamond Bar, CA (US)

(21) Appl. No.: 19/380,179

(22) Filed: Nov. 5, 2025

Related U.S. Application Data
(60) Provisional application No. 63/719,418, filed on Nov. 12, 2024.
(60) Provisional application No. 63/798,088, filed on May 1, 2025.
(60) Provisional application No. 63/798,070, filed on May 1, 2025.
(60) Provisional application No. 63/798,255, filed on May 1, 2025.
(60) Provisional application No. 63/804,871, filed on May 13, 2025.
(60) Provisional application No. 63/804,900, filed on May 13, 2025.
(60) Provisional application No. 63/816,910, filed on Jun. 3, 2025.
(60) Provisional application No. 63/816,975, filed on Jun. 3, 2025.
(60) Provisional application No. 63/818,419, filed on Jun. 5, 2025.
(60) Provisional application No. 63/825,999, filed on Jun. 18, 2025.
(60) Provisional application No. 63/840,912, filed on Jul. 9, 2025.
(60) Provisional application No. 63/841,496, filed on Jul. 10, 2025.

(51) Int. Cl. G06Q 20/20; G06Q 20/40; G06V 40/40

(52) U.S. Cl. CPC G06Q 20/202; G06Q 20/40145; G06V 40/45

(57) ABSTRACT

A modular biometric retrofit device and universal mounting assembly are disclosed herein. The device integrates RGB and near-infrared imaging, anti-spoofing optics, an internal rechargeable battery, and a USB-C power and data interface within a compact housing that can be attached to existing point-of-sale terminals, kiosks, handheld payment units, drive-thru menu boards, order-confirmation screens, speaker boxes, and humanoid robots for adding biometric identification capabilities thereto. The universal mounting assembly includes a variety of interchangeable mechanical and electrical adapters—clamp, suction, recessed, magnetic, adhesive, and vendor-specific brackets—enabling attachment without modification of host hardware. The retrofit device provides multi-spectral liveness detection, extended-range operation, and secure data communication for payment authorization, creating a standardized platform for biometric identification across retail and service environments.

### CROSS-REFERENCE TO RELATED APPLICATIONS

This application claims the benefit of priority under 35 U.S.C. § 119(e) to the following U.S. Provisional Patent Applications, each incorporated herein by reference in its entirety: U.S. Provisional Patent Application No. 63/719,418—Cable Configuration for Biometric Retrofit (filed Nov. 12, 2024); U.S. Provisional Patent Application No. 63/778,826—Improved Biometric Retrofit Modules for Payment Machines (filed Mar. 27, 2025); U.S. Provisional Patent Application No. 63/798,070—Biometric Camera Module Capable of Both Face and Palm Recognition (filed May 1, 2025); U.S. Provisional Patent Application No. 63/798,088—Universal Mounting Adapters for Biometric Modules (filed May 1, 2025); U.S. Provisional Patent Application No. 63/798,255—Biometric Retrofit of Clover POS Machines (filed May 1, 2025); U.S. Provisional Patent Application No. 63/804,871—Modular Mounting System for Biometric Camera Integration with Self-Service Kiosks (filed May 13, 2025); U.S. Provisional Patent Application No. 63/804,900—Biometric Retrofit of Square POS and Payment Terminals (filed May 13, 2025); U.S. Provisional Patent Application No. 63/816,910—Devices for Adding Biometric Capabilities to Payment Terminals (filed Jun. 3, 2025); U.S. Provisional Patent Application No. 63/816,975—Modular Mounting Assemblies for Biometric Camera Integration with Ingenico Terminals (filed Jun. 3, 2025); U.S. Provisional Patent Application No. 63/818,419—Mounting Apparatus for Biometric Camera Integration with NCR Terminals (filed Jun. 5, 2025); U.S. Provisional Patent Application No. 63/825,999—Enhanced Multi-Modal Drive-Thru Authentication System (filed Jun. 17, 2025); 63/841,496—Extended-Range Palm Recognition System for Drive-Thru and Stadium Authentication (filed Jul. 10, 2025); and U.S. Provisional Paten Application No. 63/840,912 —Humanoid Robot Equipped with Biometric Payment Processing System (filed Jul. 9, 2025).

### BACKGROUND OF THE INVENTION

### Field of the Invention

The present invention relates to biometric authentication and, more particularly, to retrofit devices and universal mounting assemblies that enable secure biometric identification to be added to existing payment and service hardware.

### Background

Various types of payment terminals, kiosks, and displays are known in the art, including those used in connection with payment systems, for customer rewards, customer loyalty systems, and other systems associated with secure identification. In retail settings these systems involve the use of some type of a point of sale (POS) terminal. The POS terminal can take many forms, from a stand-alone terminal connected to a cash register, a tablet computer running a POS application, a grocery store self-checkout station, or terminals built into other devices like gas pumps, vending machines, ATMs, kiosks, drive thru applications, and other variations.

Such systems often have the ability to read a credit/debit card either by swiping the card through a magnetic card reading strip, or through the use of a card chip reader. Further, POS systems are typically enabled with near field communication (NFC) technology, which can read a card that is in very close proximity to the terminal by interacting with the chip on the card. Further still, typically terminals can also interface using NFC technology to communicate with a payment application running on a smart phone. This allows a user to pay using their phone as a proxy for the credit card, by holding the phone near the POS terminal.

Such systems, however, vary widely in size, shape, location, and other characteristics. As such, it is very difficult to modify or retrofit systems to additional hardware and software components, including those associated with advanced systems of identification.

There is no standardized way to retrofit existing terminals to accommodate biometric identification systems and components. In many cases retrofits consist of using adhesives or bespoke brackets which suffer from a number of drawbacks. Adhesive mounts creep, transmit vibration, and complicate service. Bespoke brackets lack interoperability across module vendors and hosts. Furthermore, cable runs are often external and unprotected, increasing electrostatic discharge and electromagnetic discharge susceptibility and tamper risk. Prior art retrofits also struggle to deal with head produced by the terminals/modules, and may interfere with contactless antennas unless mechanically isolated and properly grounded.

Integrating new sensors often requires hardware redesign or replacement. Outdoor and drive-thru applications demand longer capture ranges, weatherized components, and robust anti-spoofing illumination beyond typical indoor equipment. There is no modular retrofit that can be attached to multiple host systems without bespoke engineering.

Accordingly, there is a need for a universal, vendor agnostic mounting architecture to retrofit terminals with biometric components that provide multiple power options and a universal mounting framework adaptable to POS terminals, kiosks, handheld devices, drive-thru menu boards, order-confirmation screens, speaker boxes, and humanoid robots, thereby enabling uniform deployment and maintenance across diverse environments.

### SUMMARY OF THE INVENTION

The present invention provides a biometric identification device that can be retrofitted onto existing systems such as POS systems and the like. The retrofit device has both an internal rechargeable battery and a USB-C power and data interface, allowing continuous operation when tethered and autonomous operation when disconnected. The device houses imaging assemblies employing RGB and near-infrared sensors, active illumination, and liveness verification associated with biometric identification. The same device can be integrated with or attached to kiosks, handheld payment terminals, drive-thru menu boards, order-confirmation displays, speaker boxes, and humanoid robots.

A universal mounting assembly allows the device to be installed without modification of host equipment. It includes mechanical fixtures such as clamps, suction cups, recessed mounts, magnetic bases, adhesive plates, and slide-lock brackets, and further includes electrical adapters enabling standardized data and power transfer. Vendor-specific interface plates provide precise fitment for Clover, Square, NCR, and Ingenico terminals. Extended-range embodiments incorporate higher-intensity infrared emitters and optical filters for vehicle-distance authentication. Humanoid robotic embodiments integrate the same core module on articulated platforms communicating securely with payment networks.

### BRIEF DESCRIPTION OF THE DRAWINGS

FIG. 1A is a perspective view of a biometric retrofit device secured to a mobile device.

FIG. 1B is a perspective view of the biometric retrofit device of FIG. 1A unmounted.

FIG. 1C is a front perspective view of the biometric retrofit device.

FIG. 1D is a back perspective view of the biometric retrofit device.

FIG. 1E is a front perspective view of the biometric retrofit device mounted on a system.

FIG. 1F is a back perspective view of the biometric retrofit device mounted on a system.

FIG. 1G is a side perspective view of the biometric retrofit device mounted on a system.

FIG. 1I is a front perspective view of the biometric retrofit device mounted on a system.

FIG. 1J is a side perspective view of the biometric retrofit device mounted on a system.

FIG. 2A is an exploded view showing internal components including camera, circuit boards, battery, and connectors.

FIG. 2B is a schematic drawing of the biometric retrofit device.

FIG. 3A is a top perspective view of a cable configuration bridging USB-C to Ethernet and Ethernet to USB connections between the biometric retrofit device and a dummy system.

FIG. 3B is a partial bottom perspective view of a cable configuration bridging USB-C to Ethernet and Ethernet to USB connections between the biometric retrofit device and a dummy system.

FIGS. 3C-F are views of connections between the biometric retrofit device and a handheld system.

FIGS. 3G-H show views of the connection ports of the biometric retrofit device.

FIG. 3I shows a back view of the biometric retrofit device secured to a system.

FIGS. 4A-B show a kiosk installation with the biometric camera module mounted above a display.

FIGS. 5A-H show various attachments for securing the biometric retrofit device to a system, including clamp, suction, and recessed or adhesive mounting adapters.

FIGS. 6A-B shows the biometric retrofit device secured to a Clover point-of-sale retrofit.

FIG. 7 shows the biometric retrofit device secured to a Square point-of-sale retrofit.

FIGS. 8A-F show various views of the biometric retrofit device used with an extended-range drive-thru unit.

FIG. 9 shows a humanoid robot embodiment of the biometric retrofit device.

FIGS. 10A-D show an NCR terminal mounting assembly with the biometric retrofit device secured thereto.

FIGS. 11A-B show an Ingenico terminal mounting assembly with the biometric retrofit device secured thereto.

### DETAILED DESCRIPTION OF THE PREFERRED EMBODIMENTS

A modular biometric retrofit device 10 is provided that attaches to or integrates within existing payment and service hardware. The device 10 operates in indoor and outdoor environments and is designed for multi-vendor interoperability.

The device 10 includes a sealed housing enclosing various components including an RGB camera, near-infrared imaging sensors, illumination sources, control electronics, and a processor executing biometric enrollment and matching algorithms. A power subsystem contains both an internal rechargeable battery and a communication port (such as USB-C or the like) used simultaneously for charging and data communication. Wireless connectivity or an Ethernet bridge can also be included.

The mounting system of the device 10 comprises multiple interchangeable adapters adapted to secure the device 10 to a wide variety of POS systems and the like, including clamps for securing to bezel edges, suction or magnetic mounts for smooth surfaces, recessed or adhesive plates for flush installations, and slide-lock brackets for use with standardized payment terminals. Electrical adapters align and secure to USB-C or Ethernet, or other types of, connectors with host ports to provide reliable power and data connections with the device 10.

In a kiosk, the retrofit device 10 mounts above or beside the display for ergonomic acquisition palm prints or facial images used for biometric identification. In handheld terminals, the device 10 can attach to thereto typically to the rear surface, drawing power through the terminal's USB-C (or similar) port while recharging the device's internal battery, and enabling data communicating via standard interfaces.

For outdoor use, such as with drive thru ordering systems, the device 10 can be mounted on menu boards, order-confirmation screens, or speaker boxes using weather-sealed adapters. Extended-range optics and high-intensity infrared illumination enable accurate recognition of users seated in vehicles while maintaining robust liveness detection.

The device 10 includes multiple vendor-specific mounts, such as mounts for Clover, Square, NCR, and Ingenico embodiments which employ interface plates matching each manufacturer's mounting geometry while maintaining the same biometric module and universal electrical connector arrangement. The universal assembly thereby supports quick field conversion between host platforms.

A humanoid robot can integrate with the device 10 within its head or torso to capture and authenticate user biometrics. The robot communicates with a secure payment network via wired or wireless link, authorizing transactions autonomously and providing hands-free service experiences.

During operation, the imaging assembly of the device 10 captures multi-spectral images, performs liveness verification for anti-spoofing purposes, generates biometric templates, and transmits authentication data to the host device or payment network. The design allows field installation without alteration of existing hardware on the systems to which the device 10 is secured, and uniform deployment across industries.

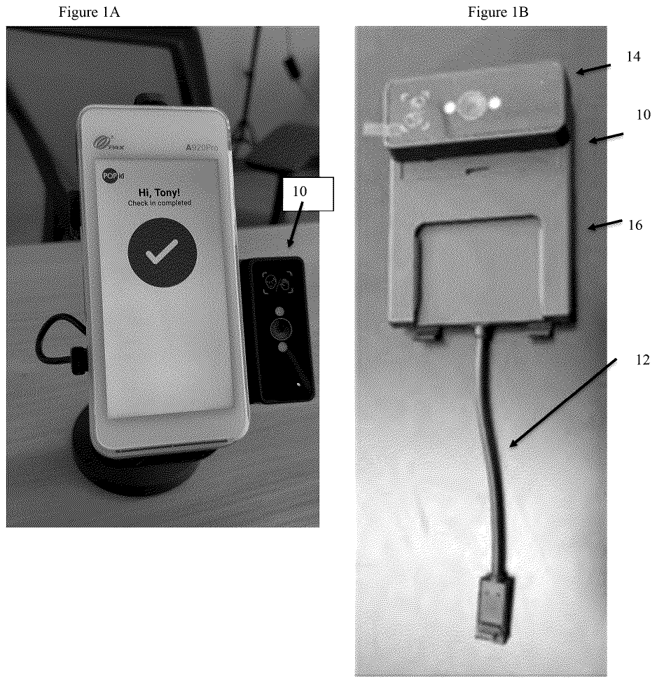

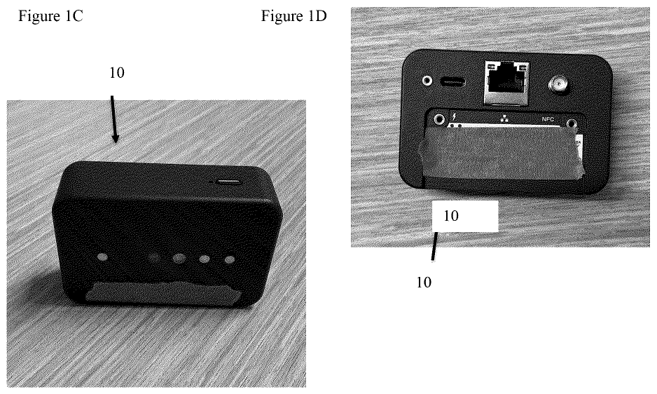

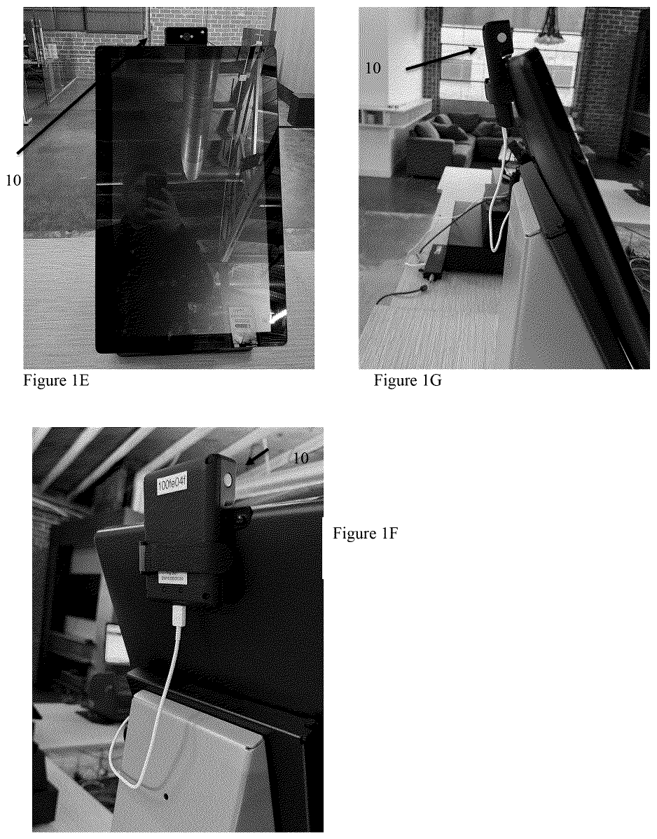

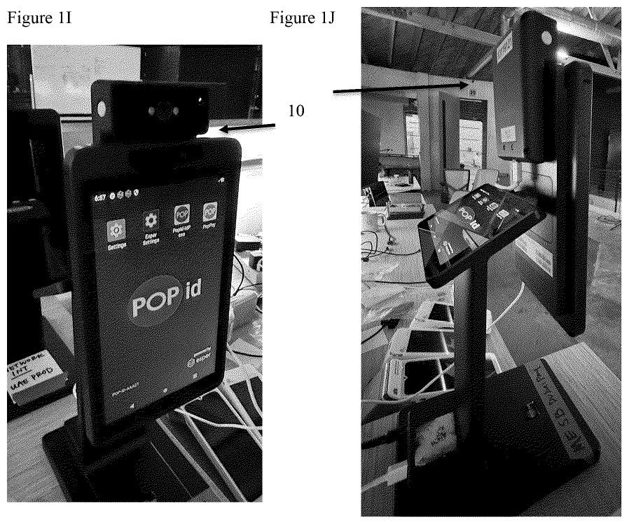

FIG. 1A shows the device 10 attached to a mobile device to provide biometric identification capability to the mobile device as it acts as a POS terminal or similar device. The device 10 and the mobile device secured to a stand, and a USB or other connector cable 12 connects the device 10 to the mobile device for the purpose of data exchange and for powering the device 10 (though its rechargeable battery).

FIG. 1B shows the device 10 including the body 14 housing the components of the device 10, and the base portion 16.

FIG. 1C shows a front view of the body 14 of the device 10, including multiple sensors such as NIR (near-infrared) sensors, LED sensors, distance sensors, and the like. FIG. 1D shows a back view of the body 14, and the various connection points such as for a power connector, Ethernet connector, cable, and the like.

FIGS. 1E-H show the device 10 attached to a terminal device using a bracket and strap making the connection therebetween, and providing retrofit biometric identification capability to the device.

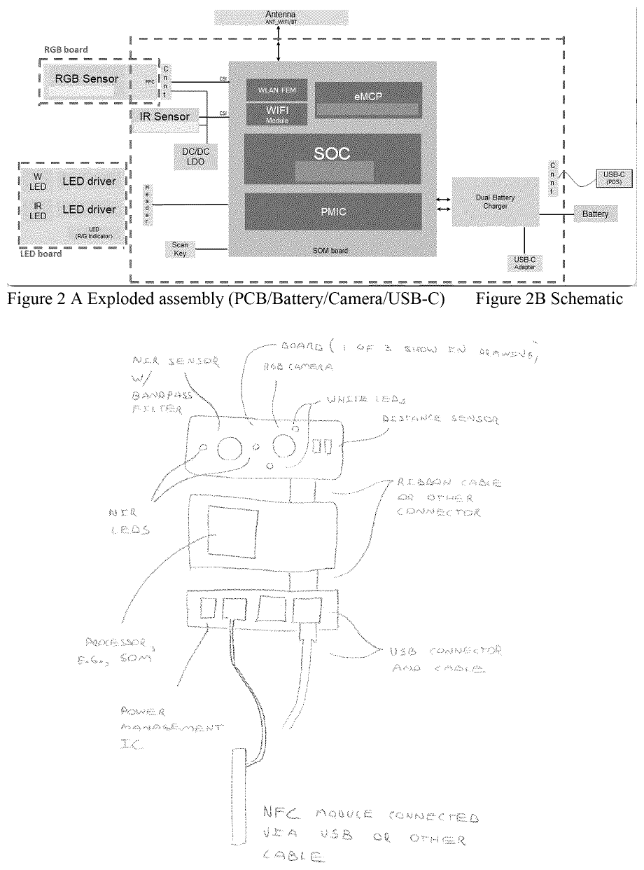

FIGS. 2A-B are schematic diagrams of the device 10. The device 10 includes a main system on module board (SoM) which contains the main system on a chip processor (SoC), a power management integrated circuity (PMIC), on board embedded multi-chip package (eMCP) unit that combines various types of memory for the device 10. The device 10 has wireless communication capability through a WIFI module and antenna, and/or a wireless local area network front end module (WLAN FEM). The device 10 has a chargeable battery module, where the device 10 can be externally powered through a plug-in connection, or powered via an on-board rechargeable battery. Various sensors described above are built into the device 10 including IR, RGB, LED, and the like. A DC/DC LDO unit provides efficient voltage regulation and noise filtering capability.

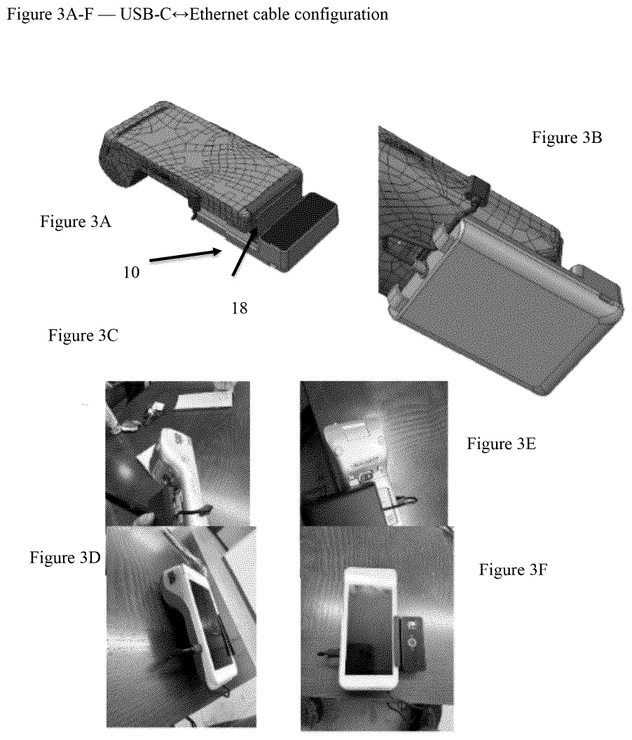

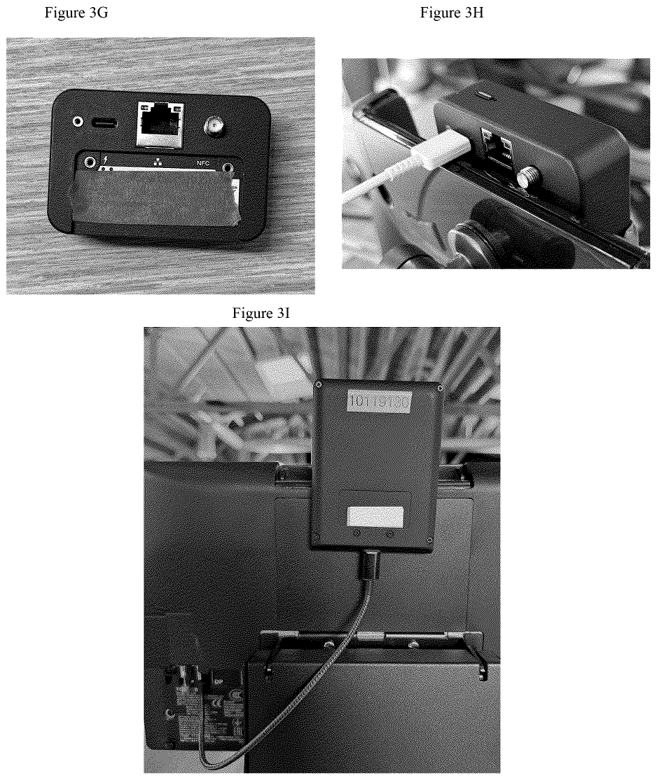

FIGS. 3A-I show various embodiments of the device 10 using a USB to Ethernet (or other) connection. The device 10 attaches to the POS system by wedging the system between base 16 and bracket 18. A cable from the Ethernet port on the device 10 attaches to the USB port on the device. FIGS. 3C-F show a similar connection, however the device 10 can secure to the top or side of the system.

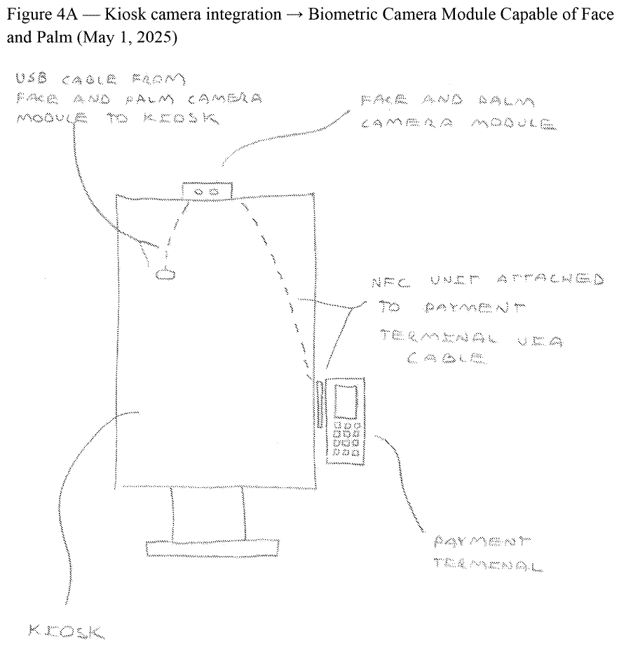

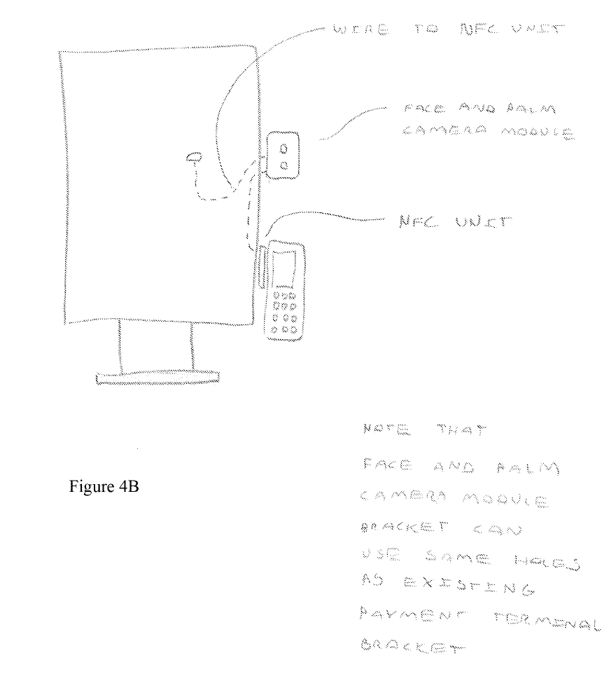

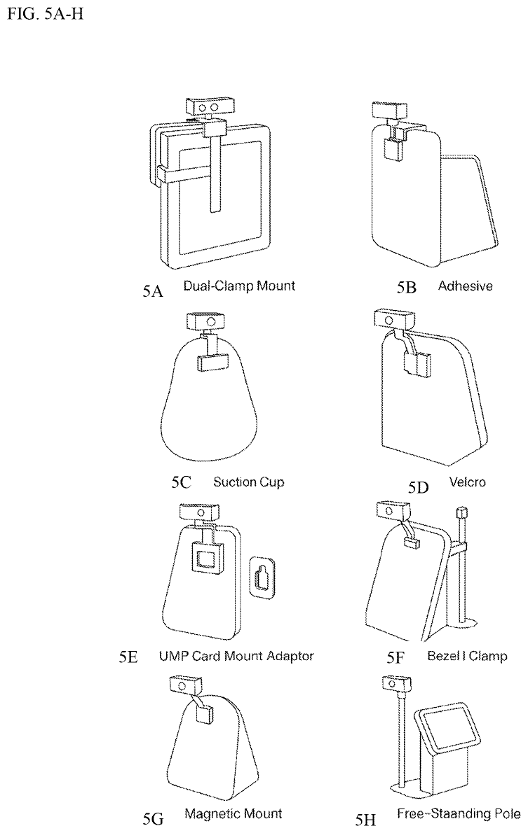

FIG. 4A is a schematic diagram of the device 10 secured to a system comprising a kiosk with a payment terminal. The device 10 is secured to the top of the kiosk and interfaces therewith via a USB connection, and interfaces with the payment terminal to allow for near field communication (NFC) via a cable for communicating information such as for non-contact payment details.

FIG. 4B shows an interface with a kiosk and payment terminal similar to that shown in FIG. 4A, where the device 10 uses face and palm recognition sensors as shown in the Figure.

FIG. 5 shows various mounts and mounting methods for the device 10. In particular, FIG. 5A shows a dual clamp mount where the device secures to the POS system with a clamp on the front and the side. FIG. 5B shows an adhesive mount, for example using double sided adhesive to secure the device 10 to the system. FIG. 5C shows the use of a suction cup to secure the device 10 to the system. FIG. 5D shows the use of hook and loop fastener connection (Velcro) to secure the device 10 to the system. FIG. 5E uses a universal mounting plate (UMP) design to secure the device 10 to the system. FIG. 5F uses a bezel clamp to secure the device 10 to the system. FIG. 5G uses a magnetic mount to secure the device 10 to the system. FIG. 5F uses a free standing pole to secure the device 10 within close proximity to the system.

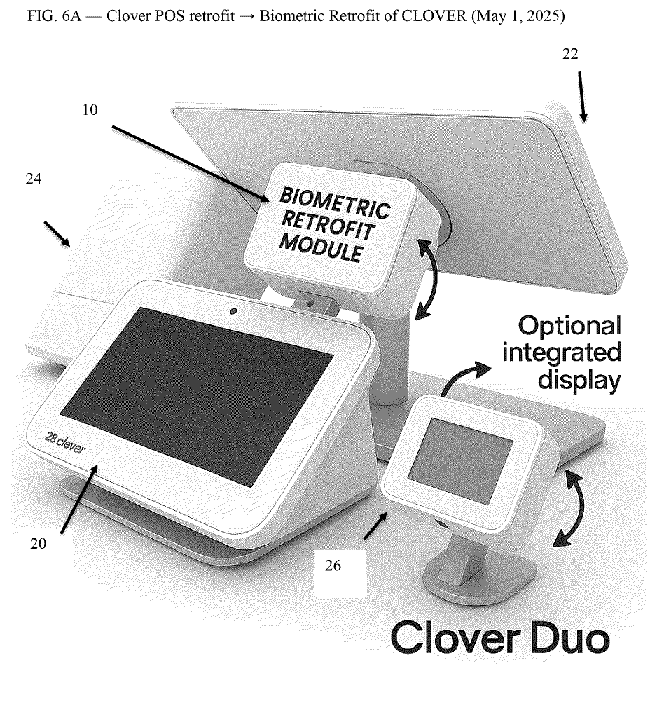

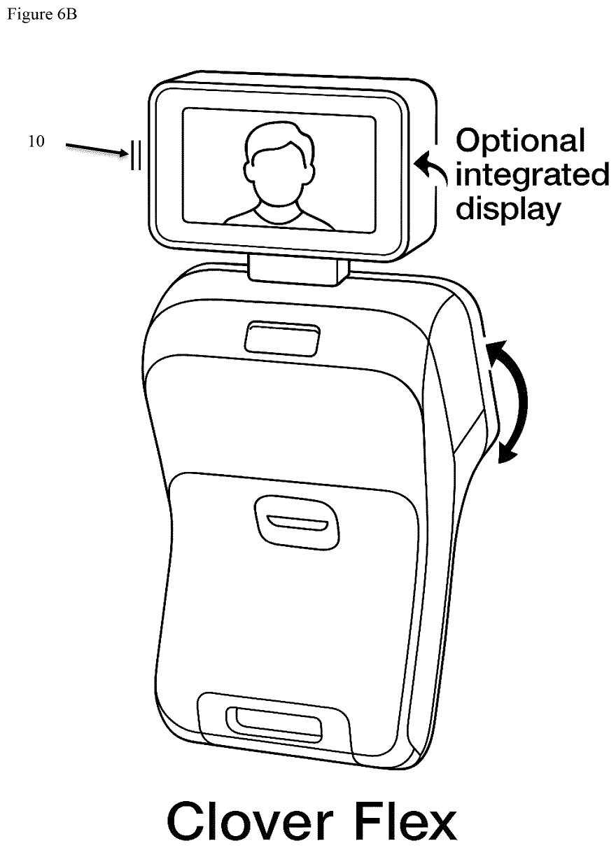

FIG. 6A shows an implementation of a retrofit specific to a POS system manufactured by Clover. This implementation includes the device 10 secured to a customer facing screen 20. The system also includes a merchant facing screen 22, a printer 24, and an additional integrated display 26.

FIG. 6B shows the device 10 integrated with a different Clover POS system, which is comprised of a single handheld POS system with the device attached and integrated thereto.

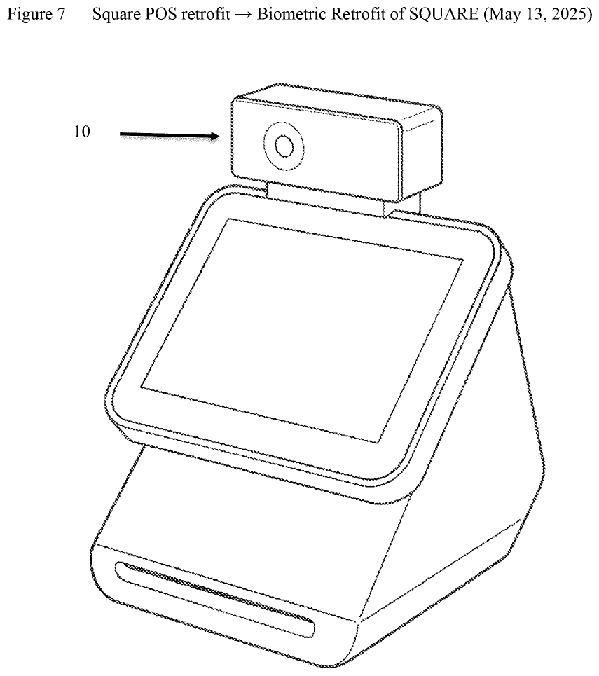

FIG. 7 shows the device 10 as a retrofit onto a POS system provided by Square, where the device 10 is secured to the top of the system.

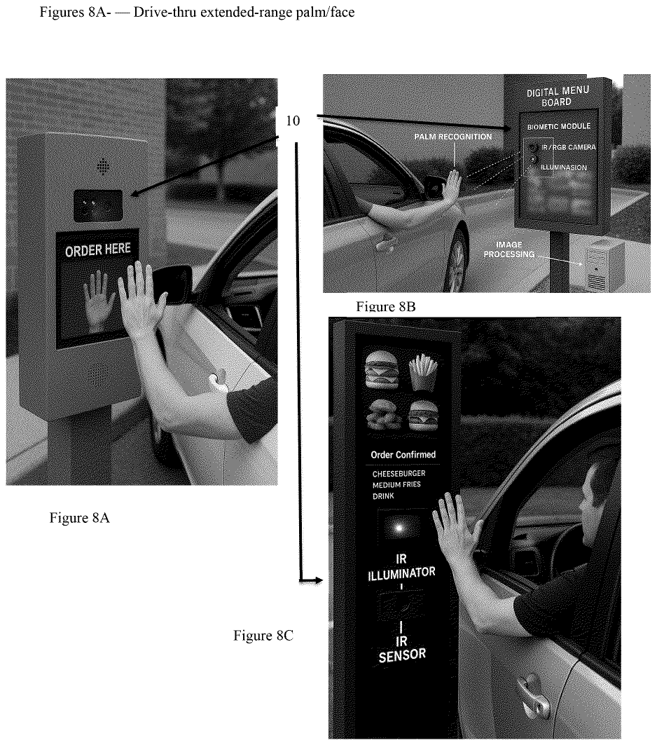

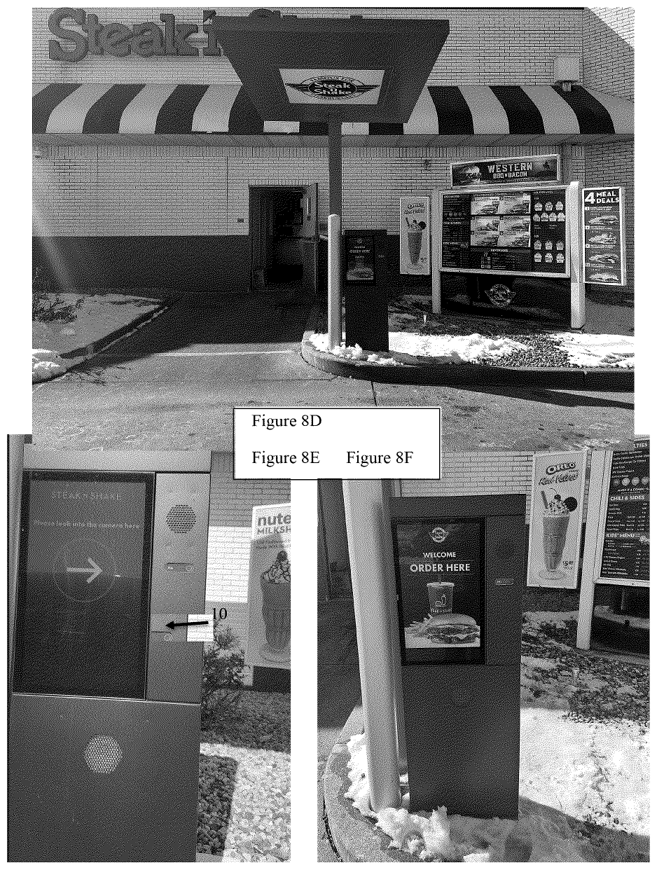

FIGS. 8A-F show various implementations of the device 10 with drive through ordering systems, wherein the device 10 provides biometric identification capability to the ordering systems.

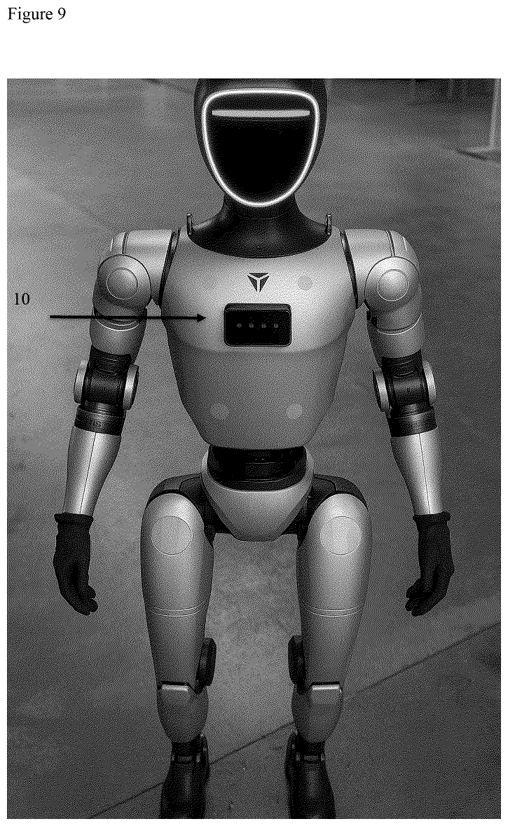

FIG. 9 shows use of the device 10 with a robot to include biometric identification functionality thereto.

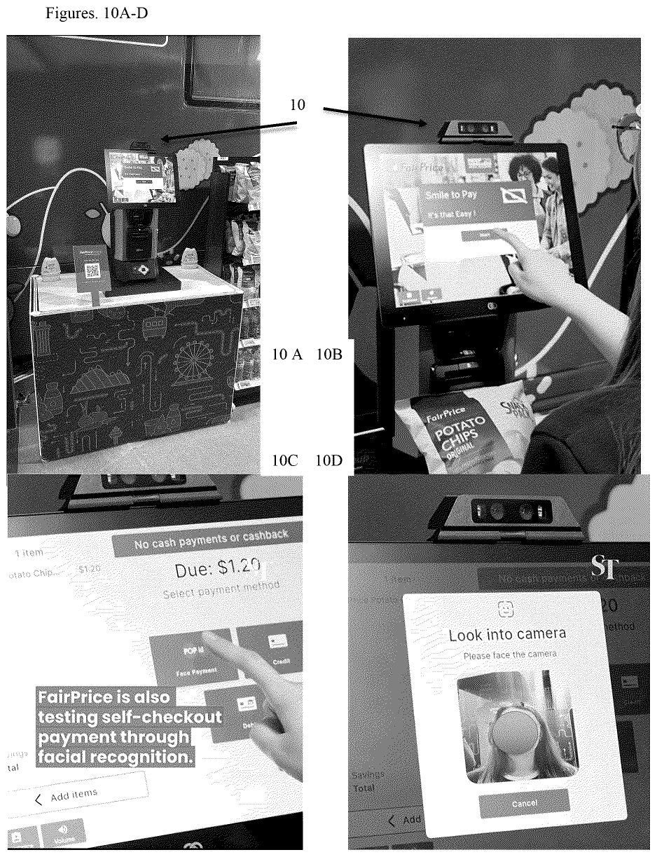

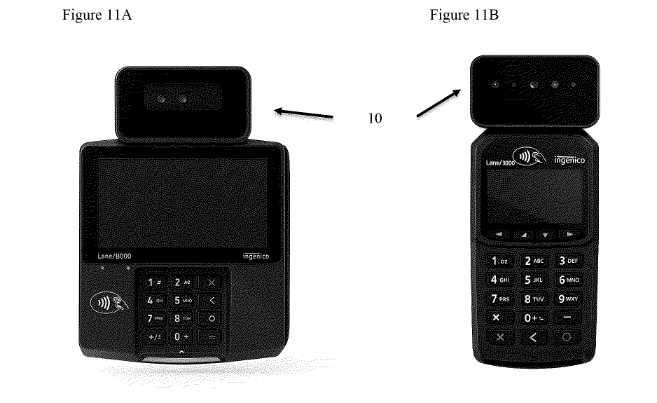

FIGS. 10A-C show the device 10 implemented with a kiosk for biometric identification capability.

FIGS. 11A-B show the device 10 integrated with a payment/credit card reading system.

It is understood that the present subject matter may be embodied in many different forms and should not be construed as being limited to the embodiments set forth herein. Rather, these embodiments are provided so that this subject matter will be thorough and complete and will convey the disclosure to those skilled in the art. Indeed, the subject matter is intended to cover alternatives, modifications, and equivalents of these embodiments, which are included within the scope and spirit of the subject matter as defined by the appended claims and their equivalents. Furthermore, in the detailed description of the present subject matter, numerous specific details are set forth in order to provide a thorough understanding of the present subject matter. However, it will be clear to those of ordinary skill in the art that the present subject matter may be practiced without such specific details.

Aspects of the present disclosure may be described herein with reference to flowchart illustrations and/or block diagrams of methods, apparatuses (systems), and computer program products according to embodiments of the disclosure. It will be understood that some blocks of the flowchart illustrations and/or block diagrams, and combinations of blocks in the flowchart illustrations and/or block diagrams, may be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

References to computer-readable media generally includes all types of computer-readable media, including magnetic storage media, optical storage media, and solid-state storage media. It should be understood that any software may be installed in and sold with the device. Alternatively, the software may be obtained and loaded into the device, including obtaining the software via a disc medium or from any manner of network or distribution system, including, for example, from a server owned by the software creator or from a server not owned but used by the software creator. The software can be stored on a server for distribution over the Internet, for example.

Computer-readable storage media (medium) can be accessed by a computing device and/or processor(s), and include volatile and non-volatile internal and/or external media that is removable and/or non-removable. For computing devices, the various types of storage media accommodate the storage of data in any suitable digital format. It should be appreciated by those skilled in the art that other types of computer readable medium can be employed such as zip drives, solid state drives, magnetic tape, flash memory cards, flash drives, cartridges, and the like, for storing computer executable instructions for performing the novel methods (acts) of the disclosed architecture.

The terminology used herein is for the purpose of describing particular aspects only and is not intended to be limiting of the disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

For purposes of this document, each process associated with the disclosed technology may be performed continuously and by one or more computing devices. Each step in a process may be performed by the same or different computing devices as those used in other steps, and each step need not necessarily be performed by a single computing device.

Although the subject matter has been described in language specific to structural features and/or methodological acts, it is to be understood that the subject matter defined in any appended claims is not necessarily limited to the specific features or acts described above. Rather, the specific features and acts described above are disclosed as example forms of implementing any claims.

1. A biometric retrofit device comprising an imaging assembly, an anti-spoofing subsystem, a rechargeable internal battery, a power and data interface, and a processor configured to perform biometric authentication and communicate with a host device.

2. The device of claim 1, further comprising a universal mounting assembly configured to secure the device to a host terminal without modification.

3. The device of claim 1, wherein the power and data interface is a USB-C interface and the rechargeable battery is chargeable through the USB-C interface while the device is operating.

4. The device of claim 1, wherein the imaging assembly includes RGB and near-infrared sensors for multi-spectral capture.

5. The device of claim 1, wherein the anti-spoofing subsystem performs depth and reflectance-based liveness detection.

6. A biometric retrofit system comprising a retrofit device and a universal mounting assembly, the mounting assembly including interchangeable adapters selected from clamp, suction, recessed, magnetic, and adhesive mounts.

7. The system of claim 6, wherein the mounting assembly further includes vendor-specific interface plates compatible with Clover, Square, NCR, and Ingenico terminals.

8. The system of claim 6, wherein the universal mounting assembly provides both mechanical attachment and electrical alignment for data and power connection.

9. The system of claim 6, wherein the retrofit device is attached to a kiosk, handheld terminal, or drive-thru apparatus.

10. The system of claim 6, wherein the retrofit device is integrated into a humanoid robot.

11. The system of claim 6, wherein the retrofit device and universal mounting assembly are weather-resistant for outdoor use.

12. The system of claim 6, wherein the retrofit device includes infrared illumination configured for extended-range biometric capture.

13. The system of claim 6, further comprising a cable-bridging assembly converting USB-C to Ethernet and Ethernet to USB for restricted I/O environments.

14. The system of claim 6, wherein the retrofit device communicates with a host payment network via the USB-C interface or a wireless link.

15. A universal mounting assembly comprising interchangeable mechanical adapters and electrical connectors configured to attach a biometric module to diverse host devices.

16. The assembly of claim 15, wherein the mechanical adapters include clamp, suction, recessed, magnetic, and adhesive mounts.

17. The assembly of claim 15, wherein the electrical connectors include USB-C, Ethernet, and proprietary vendor adapters.

18. The assembly of claim 15, wherein the mounting assembly is manufactured as a modular kit enabling field conversion between host platforms.

19. A method for retrofitting existing payment hardware with biometric capability comprising attaching a biometric module to a host device using a universal mounting assembly and establishing electrical communication through a standardized connector.

20. The method of claim 19, further comprising capturing biometric data, performing liveness verification, and transmitting authentication data to a payment processor.

21. The method of claim 19, wherein the host device is a kiosk or self-service terminal.

22. The method of claim 19, wherein the host device is a handheld payment terminal.

23. The method of claim 19, wherein the host device is a drive-thru menu board, order-confirmation screen, or speaker box.

24. The method of claim 19, wherein the host device is a humanoid robot configured for autonomous payment.

25. The method of claim 19, further comprising powering the biometric module through both an internal battery and a USB-C connection.

26. The method of claim 19, wherein the universal mounting assembly provides standardized attachment and electrical alignment for multiple vendors'terminals.

27. A drive-thru biometric capture system comprising a menu board or display enclosure, a retrofit biometric module mounted thereto, and a processor configured to authenticate users within a vehicle.

28. The system of claim 27, wherein the biometric module includes infrared illumination optimized for extended-range capture through glass.

29. A humanoid robotic payment system comprising a mobile robot and a biometric module integrated within the robot and connected to a payment network for secure autonomous transactions.

30. A modular biometric ecosystem comprising the retrofit device of claim 1, the universal mounting assembly of claim 15, and host devices selected from kiosks, handheld payment terminals, drive-thru equipment, and robotic systems.
